(19) United States
(12) Patent Application Publication
(10) Pub. No.: US 2026/0005944 A1
(43) Pub. Date: Jan. 1, 2026

(54) DYNAMIC METRICS COLLECTION BASED ON SERVER LOAD

(71) Applicant: Oracle International Corporation, Redwood City, CA (US)

(72) Inventors: Ankur Nigam, Pleasanton, CA (US); Mark Anthony Lemoine, Livermore, CA (US); Narasimha Rao Gogineni, Frisco, TX (US)

(21) Appl. No.: 18/754,432

(22) Filed: Jun. 26, 2024

(51) Int. Cl. H04L 43/0876

(52) U.S. Cl. CPC H04L 43/0876

(57) ABSTRACT

Technology disclosed herein includes systems and methods for collecting server metrics. More specifically, systems and methods for performing dynamic metric collection are disclosed in which the metrics collected are throttled based on server load. In an embodiment of the technology, an agent on a server identifies a metric to collect and determines if the current processing load on the server is above a threshold for the metric. If the processing load is below the threshold, the agent collects the metric. If the processing load is above the threshold, the agent does not collect the metric. Load thresholds may differ between metrics based on how critical the metric is defined to be.

### TECHNICAL FIELD

Various embodiments of the present technology generally relate to cloud computing, and more specifically to systems and methods for collecting metrics from servers associated with cloud-based services.

### BACKGROUND

Software as a Service (SaaS) is a software distribution model in which applications are hosted by a third-party provider and made available to customers over the internet. SaaS products rely on a robust infrastructure of servers including web servers, application servers, database servers, file servers, and cache servers.

Metrics collection on these servers is crucial for monitoring performance, ensuring security, and optimizing resources. Metrics such as CPU usage, memory usage, network traffic, and application response times are typically monitored. The collection of these metrics is often achieved through a method known as agent-based collection. In an agent-based collection system, software agents installed on each server collect and transmit data to a central monitoring tool. These agents can provide detailed insights into the system’s performance and health through collection of some or all of the metrics listed above.

The effectiveness of a SaaS solution depends on the seamless integration and effective monitoring of the aforementioned servers and metrics. However, metrics monitoring is known to add additional load on a server. Although the impact of the added load is generally designed to be minimal, the resources required to continually monitor servers and CPU loads can exacerbate server performance issues during periods of high load and place additional strain on the servers.

It is with respect to this general technical environment that aspects of the technology disclosed herein have been contemplated. Furthermore, although a general environment has been discussed, it should be understood that the examples described herein should not be limited to the general environment identified in the background.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments of the present technology generally relate to systems and methods for collecting server metrics. More specifically, some embodiments relate to systems and methods for dynamically collecting server metrics based on server load. In accordance with an embodiment of the present technology, a method of operating a server includes identifying a metric associated with the server to collect and determining if a processing load on the server is above a threshold associated with the metric. If the processing load is above the threshold, the method includes not collecting the server metric, and, if the processing load is not above the threshold, the method includes collecting the server metric.

In some embodiments, determining if the processing load is above the threshold includes checking a configuration file comprising thresholds associated with a plurality of server metrics. The method, in some embodiments, further includes providing the server metric to a monitoring service external to the server. Collecting the server metric, in certain embodiments, includes querying a collection agent on the server to collect the metric. The method may further include, if the processing load is not above the threshold, determining that at least one metric collection process is already running and determining that the at least one metric collection process must complete before collecting the metric. The server, in some examples, is an application server or a database server. The processing load, in some examples, is an average load on the central processing unit of the server over a period of time. The server, in some examples, is a virtual machine.

In another embodiment, one or more computer-readable storage media have program instructions stored thereon for collecting metrics on a server. The program instructions, when read and executed by a processing system, direct the processing system to at least identify a metric associated with the server to collect and determine if a processing load on the server is above a threshold associated with the metric. If the processing load is not above threshold, the processing system collects the server metric. If the processing load is above the threshold, the processing system does not collect the server metric.

In yet another embodiment, a system includes one or more computer-readable storage media, a processing system operatively coupled with the one or more computer-readable storage media, and program instructions stored on the one or more computer-readable storage media for collecting metrics on a server. The program instructions, when read and executed by the processing system, direct the processing system to at least identify a metric associated with the server to collect and determine if a processing load on the server is above a threshold associated with the metric. If the processing load is below the threshold, the program instructions direct the processing system to collect the server metric. If the processing load is above the threshold, the program instructions direct the processing system not to collect the server metric.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an example of a metrics collection environment in accordance with some embodiments of the present technology;

FIG. 2 illustrates an example of a server in accordance with some embodiments of the present technology;

FIG. 3 is a flowchart illustrating a set of operations for implementing dynamic metrics collection in accordance with some embodiments of the present technology;

FIG. 4 is a flowchart illustrating a set of operations for implementing dynamic metrics collection in accordance with some embodiments of the present technology;

FIG. 5 illustrates an example of a configuration file in accordance with some embodiments of the present technology; and

FIG. 6 is an example of a computing system in which some embodiments of the present technology may be utilized.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

The present technology generally relates to the collection of server metrics. More specifically, the present technology includes systems and methods for dynamic collection of server metrics based on server load. Metrics collection on servers is crucial for maintaining optimal performance, security, and reliability of server infrastructures, particularly in environments like Software as a Server (SaaS) environments. SaaS products rely on a robust infrastructure of servers, which can include web servers, application servers, database servers, file servers, cache servers, and the like. Metrics such as CPU usage, memory usage, network traffic, and application response times may be monitored. Traditionally, metrics collection on a server is static in nature—metrics are collected at regular intervals with no consideration for server load, how critical collection of the metric is to the functionality of the system at a given time, or whether there are existing issues on the server.

The collection of metrics is often achieved through agent-based collection, in which software modules, or agents, are installed on servers to gather detailed performance data. These agents, in some examples, operate continuously, monitoring key system metrics such as CPU utilization, memory usage, network bandwidth, and application-specific metrics like transaction volumes or response times. The collected data may, in some examples, be sent to a central monitoring server or platform, where it is analyzed and visualized, sometimes in real time. Agent-based collection allows for granular control and customization of the monitoring process, as agents can be tailored to meet the specific needs of different server types or applications. Moreover, because the agents are installed directly on the servers, they can detect and report issues locally, often before they affect system performance perceptibly, enabling proactive management and maintenance.

Despite its many benefits, agent-based metrics collection is also known to impose a certain degree of load on servers due to the nature of its operation. When a monitoring agent is installed directly on a server, it runs continuously or continually in the background to collect detailed performance data. This operation consumes system resources such as CPU power and memory, which could otherwise be allocated to essential server tasks. Load increases with the frequency of data collection and the complexity of the metrics being gathered. For instance, collecting high-resolution data in real-time or monitoring multiple parameters simultaneously requires more computational effort, which can lead to a reduction in overall server performance, especially if the hardware is already near its capacity limits.

Thus, systems and methods for dynamically changing the collection of metrics based on current server loads are disclosed. In accordance with an embodiment of the present technology, a server includes a configuration file and at least one agent. The at least one agent identifies a metric to collect. Before collecting the metric, however, the at least one agent checks the CPU load on the server and compares the CPU load to a threshold associated with the specific metric identified in the configuration file. If the CPU load is at or below the threshold identified in the configuration file, the at least one agent executes the collection and reports the collected metric value(s) to a monitoring service on or external to the server. If the CPU load is above the threshold, however, the agent forgoes the collection of the metric and sends that particular metric into a backoff loop to check when the agent can resume collecting the metric.

In an exemplary embodiment of the present technology, the thresholds defined in the configuration file are based on how critical their associated metrics are. Thus, in times of high load, collection of metrics can be limited to only critical metrics to reduce load on the server. However, as the load on the server reduces, the number of metrics collected can increase as the load passes below their respective thresholds.

In some embodiments of the present technology, the server on which the metrics are dynamically collected includes at least one metrics agent and at least one exporter agent. The at least one metrics agent is responsible for determining what metrics to collect, initiating the collection of metrics by the appropriate exporter agent, checking CPU loads, checking the configuration file, reporting collected metrics back to a monitoring service, and similar tasks. The at least one exporter agent is responsible for executing the collection of the metric(s) upon initiation by the metrics agent and providing the collected metric(s) back to the metrics agent.

The configuration file is made up of one or more files that contain information regarding when to collect various server metrics. The configuration file, in some examples, includes information such as what exporter agent should handle collection of a metric, the regular interval at which the metric should be collected, whether the metric can be collected simultaneously with other metrics, how long until the metric collection should time out, the server load threshold for collecting the metric, and similar information.

It should be noted that in the modern SaaS and cloud-based landscape, servers are increasingly implemented as distributed virtual machines (VMs). In such a system, multiple virtual servers may be run on a single physical server, where each VM operates independently with its own operating system and allocated resources such as CPU, memory, and storage. Thus, in the context of this application, the term “server” may be used in a broad sense to include various forms of computing devices that deliver servers or perform tasks over a network. This includes both physical servers, which are traditional hardware-based systems located in data centers or server rooms, and virtual machines, which are software-based emulations of physical servers running on a hypervisor or hosted in a cloud environment. The term may also extend to similar entities such as containers or microservices that function in a server-like capacity, providing scalability, flexibility, and resource management.

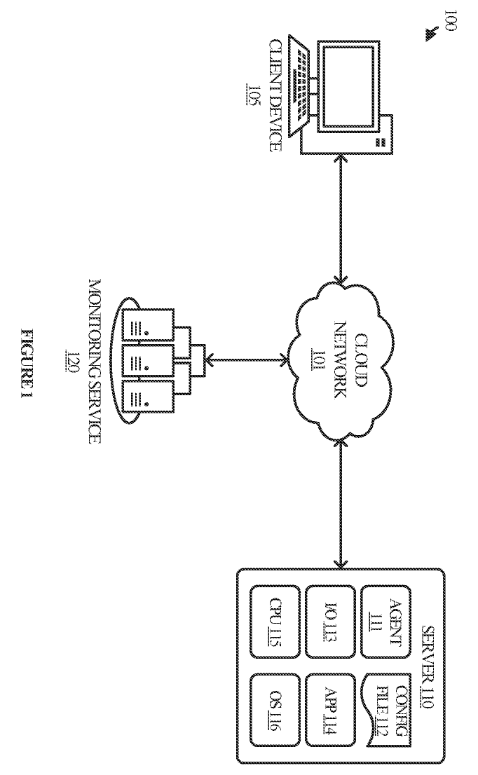

FIG. 1 illustrates service environment 100. Service environment 100 is an example of a cloud-based service environment (e.g., a SaaS environment) in which embodiments of the present technology may be implemented. Service environment 100 includes cloud network 101, client device 105, server 110, and monitoring service 120. Server 110 includes agent 111, configuration file 112, I/O interface 113, application 114, CPU 115, and OS 116. In some examples, agent 111 and configuration file 112 are a part of the same monitoring tool on server 110. The components illustrated in FIG. 1 are merely representative and are provided for the purpose of example. An actual service environment implementing the dynamic metrics collection technology described herein may vary and can include different, fewer, or additional components. It should be understood that the invention is not limited to the specific hardware configurations depicted, and various modifications and alternative implementations may be employed without departing from the scope of the invention.

Server 110 provides one or more services over cloud network 101. Client device 105 accesses server 110 via cloud network 101 for one or more services that may include storage services, computing services, or application services. For example, client device 105 may access application 114 on server 110 via cloud network 101. Monitoring service 120 also communicates with server 110 via cloud network 101. Agent 111 on server 110 is responsible for collecting metrics on server 110 and providing them to monitoring service 120 via cloud network 101. Agent 111 dynamically collects metrics on server 110 based on the load on CPU 115. To dynamically collect the metrics on server 110, agent 111 identifies metrics to collect based at least in part on configuration file 112. Configuration file 112 stores the identity of metrics to collect and an indication of how critical each metric is. The indication of how critical each metric includes a CPU load threshold.

Before collecting a metric, agent 111 checks configuration file 112 to identify the CPU load threshold associated with that metric. Agent 111 also checks the CPU load to compare to the threshold. To check the CPU load, agent 111, in some examples, queries OS 116 for the current CPU load. The current CPU load, in some examples, is an average of the CPU load over a recent period of time (e.g., 1 minute, 5 minutes, etc.). Once agent 111 has obtained the current CPU load, it compares the CPU load to the threshold for the metric identified in configuration file 112. If the CPU is below the threshold, agent 111 proceeds with collecting the metric and/or instructs one or more other agents to collect the metric and provide it back to agent 111. Once agent 111 obtains the metric value, it provides the value back to monitoring service 120 via cloud network 101.

A variety of metrics may be monitored on a SaaS server such as server 110. Application server metrics might include metrics such as status, response time, throughput, error rate, session duration, user concurrency levels, login count, error count, latency score, and other metrics related to the application server and/or the application running on the server. Examples of metrics that may be collected on a database server include query response time, transaction rates, lock waits, cache hit ratios, and other metrics related to the database server and/or the database on the server.

Metrics on server 110 may be collected from different sources within the server. For example, metrics such as CPU utilization, memory usage, and disk I/O operations may be collected from the operating system (e.g., OS 116). Network traffic and related metrics may be gathered from network interfaces of the server. Application-specific metrics like response times, error rates, and session data may be sourced directly from the application software (e.g., application 114). Database performance metrics, including query execution times and transaction rates, may be extracted from a database management system. Additionally, log files generated by both the OS and application software may also provide detailed event data and error information.

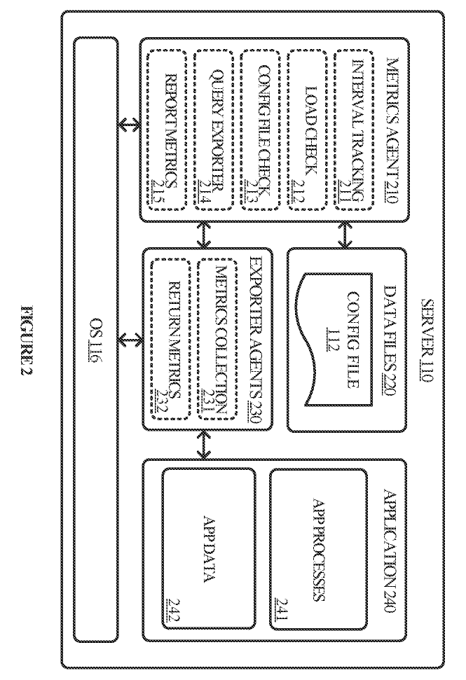

FIG. 2 illustrates a detailed view of server 110, which is representative of a server that may implement the dynamic metric collection technology disclosed herein. Server 110 includes metrics agent 210, data files 220, exporter agents 230, application 240, and operating system 116. Metrics agent 210 includes interval tracking routine 211, load check routine 212, configuration file check routine 213, query exporter routine 214, and report metrics routine 215. Data files 220 includes configuration file 112. Exporter agents 230 includes metrics collection routine 231 and return metrics routine 232. Application 240 includes application processes 241 and application data 242. In some embodiments, metrics agent 210, exporter agents 230, and configuration file 112 are a part of the same monitoring tool on server 110.

The components and routines shown in server 110 are intended to be exemplary. The actual configuration of a server used in accordance with the present disclosure may vary significantly depending on specific needs, technological advancements, or particular implementations. A server may include additional components and routines not shown in FIG. 2, such as advanced security hardware, additional storage or database systems, or specialized network management tools. Conversely, some components shown may be omitted or replaced with different technologies that perform similar or enhanced functions. This flexibility in server configuration allows for the adaptation of the server architecture to meet diverse operational demands and technological integrations, underscoring the scalable and modular nature of the dynamic metrics collection technology illustrated herein.

Metrics agent 210 executes interval tracking routine 211, where metrics agent 210 checks the intervals identifying how often each metric should be run via configuration file 112 or a different file identifying metric intervals in data files 220. In accordance with some embodiments of the present technology, each metric collected on server 110 has an identified interval at which the metric should be checked (e.g., 1 minute, 5 minutes, 2 hours, etc.). In some cases, if CPU load stays low enough that it is not higher than any metric threshold, each of the metrics will be obtained at each of their corresponding intervals. Some metrics, however, may have further restrictions regarding whether they can be run simultaneously with other metrics or not, which may prevent all metrics from being run at each interval. Such restrictions are, in some examples, stored in configuration file 112 or another file of data files 220. Interval tracking routine 211, in some examples, includes identifying a metric to collect based on the metric’s interval.

Metrics agent 210 executes load check routine 212, where metrics agent 210 checks the CPU load on server 110 and/or a different metric identifying load on server 110. To check the CPU load or similar load metric, metrics agent 210, in some examples, queries operating system 116.

Metrics agent 210 also executes configuration file check routine 213. During configuration file check routine 213, metrics agent 210 reads configuration file 112 to find information related to a metric to collect. As previously described, identifying a metric to collect may occur during interval tracking routine 211, configuration file check routine 213, or another routine not shown in FIG. 2. During configuration file check routine 213, metrics agent 210 reads information in configuration file 112 to identify at least a CPU load limit associated with the identified metric. Metrics agent 210 may also identify other restrictions associated with the metric, such as whether the metric can be collected simultaneously with other metrics, as well as other information such as which exporter agent is responsible for handling the collection of each metric. Once metrics agent 210 identifies the CPU load limit associated with the metric that is to be collected, it compares the limit with the CPU load most recently collected when performing load check routine 212.

If the CPU load limit for the metric is below the CPU load limit identified for the metric in configuration file 112, and if no other restrictions prevent the metric collection, metrics agent 210 performs query exporter routine 214, during with metrics agent 210 queries an exporter agent of exporter agents 230. The exporter agent may be identified in configuration file 112, in some examples. Each exporter agent of exporter agents 230 runs locally on server 110 and executes the backend commands for collecting the metric(s). Once initiated during the query from metrics agent 210, the exporter agent performs metrics collection routine 231 and return metrics routine 232. During metrics collection routine 231, the exporter agent collects the metric from one or more relevant sources on server 110. For example, if the metric that metrics agent 210 identified and queried the exporter agent for is related to application 240 (e.g., response times, error rates, session data, etc.), the exporter agent may access application 240, including application data 242 to collect the metric. Alternatively, if the metric is related to the hardware, operating system, or network traffic on server 110 (e.g., CPU utilization, memory usage, disk I/O operations, etc.), the exporter agent may collect the metric from operating system 116, network interfaces on server 110, or the like. Some metrics may be collected by the exporter agent from data files 220. Database performance metrics (e.g., query execution times, transaction rates, etc.) may be collected from one or more database management systems on server 110.

Alternatively, if the CPU load limit for the metric is at or above the CPU load limit identified for the metric in configuration file 112, metrics agent does not perform query exporter routine 214 for the metric and does not query any exporter agents to collect the metric. Instead, metrics agent 210 pauses collection of the metric. To pause collection of the metric, metrics agent 210, in some examples, initiates a backoff loop routine (not shown) for the metric, during which metrics agent 210 or another component of server 110 checks the CPU load against the CPU load limit for the metric at regular intervals (e.g., the interval identified from data files 220 during interval tracking routine 211) to determine when the metric can begin to be collected again (i.e., once the CPU load is below the CPU load limit for the metric). During this time, metrics agent 210 may perform processes for collecting other metrics with different CPU load limits that are not met or exceeded by the current CPU load.

Once the exporter agent of exporter agents 230 completes the metric collection, is returns the collected metric information to metrics agent 210 in execution of return metrics routine 232. Once metrics agent 210 receives the collected metric information from the exporter agent, it reports the collected metric information to one or more places in report metrics routine 215. Metrics agent 210, in some examples, reports the collected metric information to monitoring service 120. Metrics agent 210 may also provide the metric information to one or more services running locally on server 110.

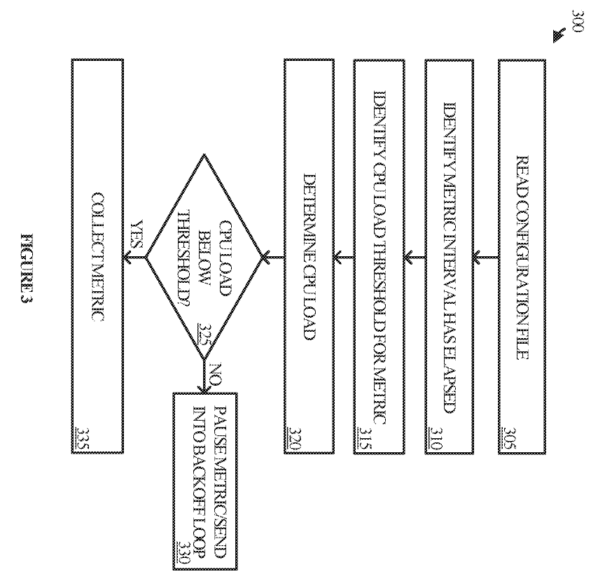

FIG. 3 illustrates process 300. Process 300 is an exemplary operation of dynamic metrics collection in service environment 100. The operations may vary in other examples. The operations of process 300, in some examples, are performed by one or more components of server 110. In some examples, the operations of process 300 are performed by metrics agent 210 and/or exporter agents 230. The operations of process 300 include reading a configuration file identifying a CPU load threshold for a metric (305). In some examples, metrics agent 210 reads configuration file 112 to identify the CPU load for the metric.

The operations of process 300 further include identifying that the interval for the metric has elapsed (step 310). In accordance with some embodiments of the present technology, each metric collected has an associated interval at which the metric is collected. For example, some metrics may be collected every one minute while others may be collected every two hours, once per day, or at other time intervals of varying duration. Once the interval for the metric has elapsed, metrics agent 210 re-initiates collection of the metric.

The operations of process 300 further include identifying the CPU load threshold for the metric (step 315). To identify the CPU load threshold, agent 111 or metrics agent 210, in some examples, checks configuration file 112, where the CPU load threshold is stored. The operations of process 300 further include determining the current CPU load for the server (step 320). In some examples, to determine the current CPU load on the server, one or more components of server 110 query operating system 116 to collect the most recent CPU load.

CPU load, as discussed herein, refers to the processing power being used by a server’s central processing unit (CPU) at a given time. CPU load indicates how many tasks or processes are actively demanding resources from the CPU. High CPU load can indicate that the server is handling a lot of requests or performing intensive computations, potentially leading to slower performance if the load consistently exceeds the CPU’s capacity.

Calculating CPU load on a server involves measuring the demand on the CPU during a specific time period and can be achieved in a several ways, which are each contemplated herein. One method of calculating the CPU load on the server is through the load average, which shows the average system load over a period of time (e.g., one minute, five minutes, or fifteen minutes). This metric can provide a rough measure of system demand. An alternative method of measuring CPU load is through the CPU utilization percentage. CPU utilization percentage is a more direct measure of load that shows the percentage of time the CPU is actively working versus being idle. CPU utilization percentage can be measure by tolls that track CPU time spent on different types of tasks (e.g., user processes, system processes, idle). Real-time monitoring tools may also be used to measure CPU load.

Thus, it should be noted that the CPU load collected on the server, in accordance with some embodiments of the dynamic metric collection technology disclosed herein, is an average CPU load over a short period of time (e.g., one minute, five minutes). Collecting an average load rather than a snapshot at a single instance in time may help provide a more stable and useful indication of the CPU’s recent activity and smooth our short-term fluctuations or noise in usage that can occur due to transient processes or temporary spikes in demand.

The operations of process 300 further include determining whether the current CPU load is below the identified threshold for the metric (step 325). To determine whether the current CPU load is below the identified threshold, one or more components of server 110 may compare the CPU load threshold identified in step 315 to the current CPU load collected in step 320. If the current CPU load is equal to or greater than the identified threshold for the metric, the server does not collect the metric and sends the metric into a backoff loop where the CPU load is monitored to determine when collection of the metric can resume (step 330). If the current CPU load is below the identified threshold for the metric, one or more components of the server collect the metric (step 335). As described in reference to the preceding Figures, some or all of step 330 and step 335 may be performed by one or more agents of server 110, such as agent 111, metrics agent 210, and/or exporter agents 230. Although, in the present example, the metric is not collected if the CPU load is at or above the threshold, in other examples the metric may be collected if the CPU load is at or below the threshold.

In some examples, process 300 includes one or more additional steps for determining whether the identified metric can be collected simultaneously with other metrics and, if not, whether other metrics are being collected prohibiting the metric from being collected. If the metric cannot run synchronously, the server may forego collection of the metric until a future interval when no other metrics are being collected. Similarly, process 300 may include one or more additional steps for determining whether a non-synchronous metric (i.e., a metric than cannot be run simultaneously) is already running and if a different metric cannot be collected as a result.

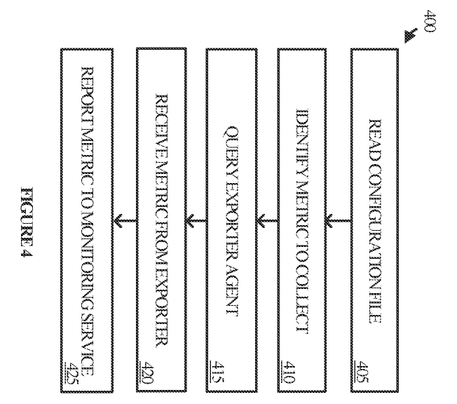

FIG. 4 illustrates process 400. Process 400 is an exemplary operation of dynamic metrics collection in service environment 100. The operations may vary in other examples. The operations of process 400, in some examples, are performed by metrics agent 210 of server 110 from FIG. 2. The operations of process 400 include reading a configuration file stored on the server (step 405). In the example of FIG. 2, metrics agent 210 reads configuration file 112. Information read from the configuration file in step 405 may include, in some examples, intervals for collecting one or more metrics on the server, CPU load thresholds for each collected metric, and the like.

The operations of process 400 further include identifying a metric to collect (step 410). Identifying a metric to collect, in some embodiments, is based on information that metrics agent 210 reads from configuration file 112. In other examples, identifying a metric to collect is based on information from a different file on the server. Identification of a metric to collect may alternatively be based on instructions from another service on or external to the server (e.g., from monitoring service 120).

The operations of process 400 further include, after determining that the CPU load is below the threshold for the metric, querying an exporter agent on the server to collect the metric (step 415). In the example of FIG. 2, metrics agent 210, after determining that the current CPU load is below the threshold for the metric, queries an exporter agent of exporter agents 230 to collect the metric. Once the exporter agent receives the query, it proceeds with the metric collection and returns the collected metric information to the requesting entity (e.g., metrics agent 210). Thus, the operations of process 400 further include receiving the metric from the exporter agent (step 420). The operations of process 400 further include reporting the metric to an external monitoring service (step 425). In the example of FIGS. 1 and 2, metrics agent 210 receives the metric from an exporter agent of exporter agents 230 (step 420) and reports the metric back to monitoring service 120 via cloud network 101. In other examples, the monitoring service may run, in whole or in part, on server 110.

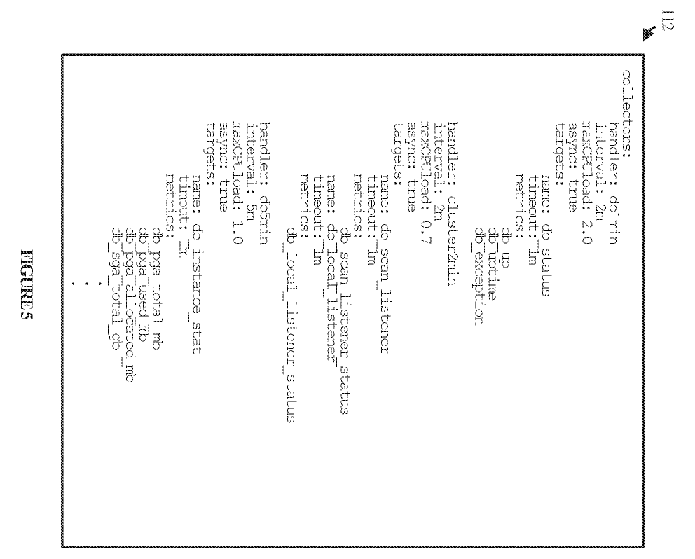

FIG. 5 illustrates configuration file 112. Configuration file 112 is broadly representative of a configuration file stored on a server storing information including CPU thresholds for various metrics collected on the server. Configuration file 112, in some examples, is hosted on server 110 as illustrated in the preceding Figures. Configuration file 112 is used by one or more agents on a server to dynamically collect metrics based on server load. Before collecting a metric, the one or more agents on the server check configuration file 112 for the CPU threshold value stored for the associated metric. If the current CPU load on the server is below (or equal to, in some cases) the threshold value for the metric, the agent will continue with the metric collection process. If the current CPU load on the server is above (or equal to, in other cases) the threshold value for the metric, the agent will forego collecting the metric until the CPU load is below the threshold value.

In the present example, configuration file 112 defines which exporter agent (“handler”) to call for the collection of each metric, the interval at which each metric is to be collected (“interval”), the maximum CPU load at which the metric to collect the metric (“maxCPUload”), whether the metric can be collected simultaneously with other metrics (“async”), the timeout duration for collecting each metric (“timeout”), and the names of each metric to collect (“name”). The information defined in configuration file 112 is merely exemplary. In other embodiments, different metrics and metric parameters may be defined in configuration file 112. Similarly, the metrics and metric parameters stored in configuration file 112 may be distributed across multiple files stored on the server, rather than in a single file.

In some embodiments, configuration file 112 includes information indicating where collected metrics are to be stored and/or sent after collection. For example, configuration file 112 may include information indicating to metrics agent 210 that a given metric should be sent to monitoring service 120 upon collection.

In some embodiments, configuration file 112 is a part of the same monitoring tool as the agent(s) responsible for collecting the metrics. For example, configuration file 112 may be installed on server 110 as part of a monitoring tool that also includes agent 111, metrics agent 210, and/or exporter agents 230.

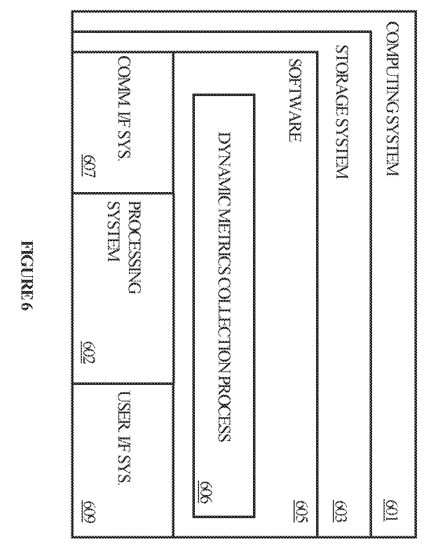

FIG. 6 illustrates computing system 601 to perform dynamic metrics collection according to an implementation of the present technology. Computing system 601 is representative of any computing system or collection of systems with which the various operational architectures, processes, scenarios, and sequences disclosed herein for collecting server metrics based on server load. Computing system 601 may be implemented as a single apparatus, system, or device or may be implemented in a distributed manner as multiple apparatuses, systems, or devices.

Computing system includes 601 storage system 603, communication interface 607, user interface 609, and processing system 602. Processing system 602 is linked to communication interface 607 and user interface 609. Storage system 603 stores software 605, which includes dynamic metrics collection process 606. Computing system 601 may include other well-known components such as batteries and enclosures that are not shown in the present example for clarity. Examples of computing system 601 include, but are not limited to, desktop computers, laptop computers, server computers, routers, web servers, cloud computing platforms, and data center equipment, as well as any other type of physical or virtual server machines, physical or virtual routers, containers, and any variation or combination thereof.

Processing system 602 loads and executes software 605 from storage system 603. Software 605 includes and implements dynamic metrics collection process 606, which is representative of the server metrics collection operations discussed with respect to the preceding figures. When executed by processing system 602 to perform the processes described herein, software 605 directs processing system 602 to operate as described for at least the various processes, operational scenarios, and sequences discussed in the foregoing implementations. Computing system 601 may optionally include additional devices, features, or functionality not discussed for purposes of brevity.

Referring still to FIG. 6, processing system 602 may include a micro-processor and other circuitry that retrieves and executes software 605 from storage system 603. Processing system 602 may be implemented within a single processing device but may also be distributed across multiple processing devices or sub-systems that cooperate in executing program instructions. Examples of processing system 602 include general purpose central processing units, graphical processing units, application specific processors, and logic devices, as well as any other type of processing devices, combinations, or variations thereof.

User interface 609 includes components that interact with a user to receive user inputs and to present media and/or information. User interface 609 may include a speaker, microphone, buttons, lights, display screen, touch screen, touch pad, scroll wheel, communication port, or some other user input/output apparatus, including combinations thereof. User interface 609 may be omitted in some examples.

Storage system 603 may include any computer-readable storage media readable by processing system 602 and capable of storing software 605. Storage system 603 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer-readable storage media a propagated signal.

In addition to computer-readable storage media, in some implementations storage system 603 may also include computer-readable communication media over which at least some of software 605 may be communicated internally or externally. Storage system 603 may be implemented as a single storage device but may also be implemented across multiple storage devices or sub-systems co-located or distributed relative to each other. Storage system 603 may include additional elements, such as a controller, capable of communicating with processing system 602 or possibly other systems.

Software 605 (including dynamic metrics collection process 606) may be implemented in program instructions and among other functions may, when executed by processing system 602, direct processing system 602 to operate as described with respect to the various operational scenarios, sequences, and processes illustrated herein. For example, software 605 may include program instructions for implementing dynamic metrics collection functionality in a cloud-based service environment as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software, virtualization software, or other application software. Software 605 may also include firmware or some other form of machine-readable processing instructions executable by processing system 602.

In general, software 605 may, when loaded into processing system 602 and executed, transform a suitable apparatus, system, or device (of which computing system 601 is representative) overall from a general-purpose computing system into a special-purpose computing system customized to provide dynamic metric collection functionality as described herein. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary storage, as well as other factors.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface 607 may include communication connections and devices that allow for communication with other computing systems (not shown) over communication networks (not shown). Examples of connections and devices that together allow for inter-system communication may include network interface cards, ports, antennas, power amplifiers, radio frequency (RF) circuitry, transceivers, and other communication circuitry. The connections and devices may communicate over communication media to exchange communications with other computing systems or networks of systems, such as metal, glass, air, or any other suitable communication media. Communication interface 607 may be configured to use Time Division Multiplex (TDM), Internet Protocol (IP), Ethernet, optical networking, wireless protocols, communication signaling, or some other communication format, including combinations thereof. The aforementioned media, connections, and devices are well known and need not be discussed at length here.

Communication between computing system 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

The techniques introduced herein may be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media or machine-readable medium suitable for storing electronic instructions.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” “platform,” “environment,” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of "including, but not limited to." As used herein, the terms "connected," "coupled," or any variant thereof means any connection or coupling, either direct or indirect, between two or more elements; the coupling or connection between the elements can be physical, logical, or a combination thereof. Additionally, the words "herein," "above," "below," and words of similar import, when used in this application, refer to this application as a whole and not to any particular portions of this application. Where the context permits, words in the above Detailed Description using the singular or plural number may also include the plural or singular number, respectively. The word "or," in reference to a list of two or more items, covers all of the following interpretations of the word: any of the items in the list, all of the items in the list, and any combination of the items in the list.

The phrases "in some embodiments," "according to some embodiments," "in the embodiments shown," "in other embodiments," and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further, any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words "means for," but use of the term "for" in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method of operating a server, the method comprising:
identifying a metric associated with the server to collect;
determining if a processing load on the server is above a threshold associated with the metric;
if the processing load is above the threshold, not collecting the server metric; and
if the processing load is below the threshold, collecting the server metric.

2. The method of claim 1, wherein determining if the processing load is above the threshold comprises checking a configuration file comprising thresholds associated with a plurality of server metrics.

3. The method of claim 1, further comprising providing the server metric to a monitoring service external to the server.

4. The method of claim 1, wherein collecting the server metric comprises querying a collection agent on the server to collect the metric.

5. The method of claim 1, further comprising, if the processing load is below the threshold:
determining that at least one metric collection process is already running; and
determining that the at least one metric collection process must complete before collecting the metric.

6. The method of claim 1, wherein the server is an application server.

7. The method of claim 1, wherein the server is a database server.

8. The method of claim 1, wherein the processing load comprises an average load on a central processing unit on the server over a period of time.

9. The method of claim 1, wherein the server is a virtual machine.

10. One or more computer-readable storage media having program instructions stored thereon for collecting metrics on a server, wherein the program instructions, when read and executed by a processing system, direct the processing system to at least:
identify a metric associated with the server to collect;
determine if a processing load on the server is above a threshold associated with the metric;
if the processing load is above the threshold, do not collect the server metric; and
if the processing load is below the threshold, collect the server metric.

11. The one or more computer-readable storage media of claim 10, wherein to determine if the processing load is above the threshold, the program instructions, when read and executed by the processing system, direct the processing system to check a configuration file comprising thresholds associated with a plurality of server metrics.

12. The one or more computer-readable storage media of claim 10, wherein the program instructions, when read and executed by the processing system, further direct the processing system to provide the server metric to a monitoring service external to the server.

13. The one or more computer-readable storage media of claim 10, wherein to collect the server metric, the program instructions, when read and executed by the processing system, direct the processing system to query a collection agent on the server to collect the metric.

14. The one or more computer-readable storage media of claim 10, wherein the program instructions, when read and executed by the processing system, further direct the processing system to, if the processing load is below the threshold:
determine that at least one metric collection process is already running; and
determine that the at least one metric collection process must complete before collecting the metric.

15. The one or more computer-readable storage media of claim 10, wherein the server is an application server.

16. The one or more computer-readable storage media of claim 10, wherein the server is a database server.

17. The one or more computer-readable storage media of claim 10, wherein the processing load comprises an average load on a central processing unit on the server over a period of time.

18. A system comprising:
one or more computer-readable storage media;
a processing system operatively coupled with the one or more computer-readable storage media; and
program instructions stored on the one or more computer-readable storage media for collecting metrics on a server, wherein the program instructions, when read and executed by the processing system, direct the processing system to at least:
identify a metric associated with the server to collect;
determine if a processing load on the server is above a threshold associated with the metric;
if the processing load is above the threshold, do not collect the server metric; and
if the processing load is not above the threshold, collect the server metric.

19. The system of claim 18, wherein to determine if the processing load is above the threshold, the program instructions, when read and executed by the processing system, direct the processing system to check a configuration file comprising thresholds associated with a plurality of server metrics.

20. The system of claim 18, wherein the program instructions, when read and executed by the processing system, further direct the processing system to provide the server metric to a monitoring service external to the server.
